(19) United States
(12) Patent Application Publication
(10) Pub. No.: US 2005/0087698 A1
(43) Pub. Date: Apr. 28, 2005

(54) Radiation image conversion panel

(75) Inventors: Takehiko Shoji, Tokyo (JP); Satoshi Honda, Tokyo (JP); Osamu Morikawa, Tokyo (JP)

Correspondence Address: Finnegan, Henderson, Farabow,;Garrett & Dunner, L.L.P., 1300 I Street, N.W., Washington, DC, 20005-3315, US

(73) Assignee: KONICA MINOLTA MEDICAL & GRAPHIC, INC.

(21) Appl. No.: 10/968,302

(22) Filed: Oct. 20, 2004

(30) Foreign Application Priority Data
Oct. 23, 2003 (JP) JP2003-363426
Oct. 23, 2003 (JP) JP2003-363447

(51) Int. Cl. G01T 1/00; G01J 1/58; G01N 21/64; H05B 33/00

(52) U.S. Cl. 250/484.4

(57) ABSTRACT

A package including: (i) a radiation image conversion panel containing a substrate having thereon a phosphor layer; and (ii) a moisture protective film surrounding the radiation image conversion panel, wherein a space formed by an inner surface of the moisture protective film and a surface of the phosphor layer is filled with a gas selected from the group consisting of N₂, He, Ne, Ar, Kr and Xe.

### FIELD OF THE INVENTION

The present invention relates to a radiation image conversion panel using a stimulable phosphor.

### BACKGROUND OF THE INVENTION

It has been known a method by which a radiation image is obtained without using a silver halide, the method uses a radiation image conversion panel in which a stimulable phosphor layer is provided on a substrate.

The method by which the radiation image is recorded using the radiation image conversion panel, is, for example, as follows. Initially, the radiation image conversion panel is fixed to a reading device, and the subject is positioned at the front of the radiation image conversion panel. Next, X-ray is irradiated onto the subject from the front, X-ray transmitted the subject is made incident on the stimulable phosphor layer, and the radiation energy corresponding to the radiation transmission density of each part of the subject is made accumulated. When an electromagnetic wave (excitation light) such as the visible ray or infrared ray is irradiated on the stimulable phosphor layer in which the energy is accumulated, and it is excited in a time series, the radiation energy accumulated in the stimulable phosphor is emitted as the stimulation light emission. When a signal by the strength of the stimulation light emission, is, for example, photo-electrically converted and made to an electric signal, it can be reproduced as a visual image on a recording material such as a silver halide photographic sensitive material, a display device such as a CRT.

It is well known that the superiority or inferiority of the radiation image conversion system using the radiation image conversion panel, is largely governed by the stimulable light emission brightness of the panel and the light emission uniformity of the panel, and particularly, these characteristics are largely controlled by the characteristic of the stimulable phosphor to be used.

Such a radiation image conversion panel is used for an X-ray image diagnosis machine for medical care. The stimulable phosphor is accumulated on a substrate on the sheet, and is accommodated in the radiation photographic cassette, and handled.

The radiation photographic cassette (hereinafter, called “cassette”) is a plain casing in which the radiation image conversion panel can be accommodated, and the physical damage of the stimulable phosphor at the time of conveyance or photographing is prevented, and a case where the excitation light is irradiated onto the stimulable phosphor after photographing and the accumulated image information is deleted, is prevented. As shown in FIG. 3, the radiation image conversion panel 30 whose stimulable phosphor layer 31 is arranged in such a manner that it is in opposite to a front plate 41 of the cassette 40, is accommodated in the cassette 40.

The radiation photography is conducted in such a manner that a subject 50 is positioned in opposite to an outside surface of the front plate 41 of the cassette 40 in which the radiation image conversion panel 30 is accommodated, an X-ray transmitted the subject 50 is made to transmit the cassette 40, and is irradiated onto the radiation image conversion panel 30. The radiation photography by this method can obtain a radiation image having an abundant information amount by a vary small exposure dose compared to a method using the silver halide.

In the photographing using the radiation image conversion panel, depending on a photographic part or photographic circumstance, there is a case where a specific performance of the radiation image conversion panel is insufficient. Specifically, in a lumbar part photography, a contrast of an image is apt to be insufficient by the influence of the low energy radiation (scattered ray) scattered when the radiation transmits the subject or the front plate of the cassette. Further, in the chest lung part photography of a high tube voltage low dose, there is a case where the brightness is insufficient and the graininess is deteriorated. In a use under the circumstance of further high temperature high humidity, there is a problem that the deterioration by the moisture absorption is accelerated. In order to improve these properties, conventionally, the improvement of the stimulable phosphor layer itself or a protective layer for sealing the stimulable phosphor layer is conducted.

Recently, a radiation panel using the stimulable phosphor in which alkali halide such as CsBr is used as a base body and to which Eu is added, is proposed, and particularly, when Eu is used as an activator, it is expected that the improvement of the X-ray conversion efficiency which is conventionally hard to realize, becomes possible.

Such a radiation image conversion panel is largely used also for X-ray image diagnostic machine for medical care. In the image diagnostic machine for medical care, particularly, for decreasing the exposure dose of the radiation irradiated on the patient, a radiation image conversion panel having a higher sensitivity and higher sharpness is required.

For improving the sensitivity and sharpness of the radiation image conversion panel, for example, in Patent Document 1, the sensitivity and sharpness are improved when the thickness of phosphor layer is in the range of 300-700 μm, and a ratio of a volume in which the stimulable phosphor occupies to all volumes of the stimulable phosphor layer, is made 85-97%.

Further, in Patent Document 2, it is shown that, when the stimulable phosphor shown by General Formula (1), particularly, the stimulable phosphor in which e shows a numeric value in the range of 0.003≦e≦0.005, is used, the high sensitivity radiation image conversion panel can be obtained.
M¹X.aM²X′₂.bM³X″₃:eA General Formula (1)

Herein, M¹ is at least one kind of alkaline metal selected from the group consisting of Li, Na, K, Rb and Cs, M2 is at least one kind of bivalent metal selected from the group consisting of Be, Mg, Ca, Sr, Ba, Zn, Cd, Cu and Ni, and M³ is at least one kind of trivalent metal selected from the group consisting of Sc, Y, La, Ce, Pr, Nd, Pm, Sm, Eu, Gd, Tb, Dy, Ho, Er, Tm, Yb, Lu, Al, Ga, and In, and X, X′, and X″ are at least one kind of halogen selected from the group consisting of F, CL, Br, and I, and A is at least one kind of metal selected from the group consisting of Eu, Tb, In, Ga, Cs, Ce, Tm, Dy, Pr, Ho, Nd, Yb, Er, Gd, Lu, Sm, Y, Tl, Na, Ag, Cu, and Mg, and a, b, e respectively show numeric values of ranges of 0≦a<0.5, 0≦b<0.5, 0<e≦0.2.

Further, a method by which a polyethylene terephthalate film or a film in which a thin film such as a metal oxide or nitric silicon is evaporated, is used as a moisture protective film, and the deterioration by the moisture absorption of the stimulable phosphor layer is prevented, is well known (for example, refer to Patent Document 3).

Further, as a method for removing the scattered rays, there is a method for absorbing the low energy radiation by providing a radiation absorption layer formed of metal or the like on the inside surface of the cassette front plate (for example, refer to Patent Document 0.4).

(Patent Document 1)

Japanese Patent Publication Open to Public Inspection (JP-A) No. 2002-214397 (2nd page)

(Patent Document 2) JP-A No. 2003-028995

(Patent Document 3) JP-A No. 2002-107495

(Patent Document 4) JP-A No. 2003-114299

However, when, under a condition that the radiation image conversion panel is fixed to the reading device, the photographing is conducted by irradiating X-ray from the front, after X-ray transmits the radiation image conversion panel, because it is scattered at the more back portion than the radiation image conversion panel of the device, and incident again on the radiation image conversion panel, and the stimulable phosphor is exposed, there is a problem that the contrast is lowered.

### SUMMARY OF THE INVENTION

An object of the present invention is to prevent a back scattering of X-ray harmful to image pick-up and to improve the contrast or sharpness of the radiation image conversion panel.

An aspect of the present invention includes a package including:
(i) a radiation image conversion panel containing a substrate having thereon a phosphor layer; and
(ii) a moisture protective film surrounding the radiation image conversion panel,
wherein a space formed by an inner surface of the moisture protective film and a surface of the phosphor layer is filled with a specific inert gas.

### BRIEF DESCRIPTION OF THE DRAWINGS

FIG. 1 is a sectional view showing an example of mode of a radiation image conversion panel of the present invention.

FIG. 2 is a sectional view showing the formation method of a stimulable phosphor layer of the radiation image conversion panel of the present invention.

FIG. 3 is a typical view showing a photographing method by using the radiation image conversion panel.

### DESCRIPTION OF THE PREFERRED EMBODIMENTS

It was found that the following embodiments are effective to solve the problems of the present invention.

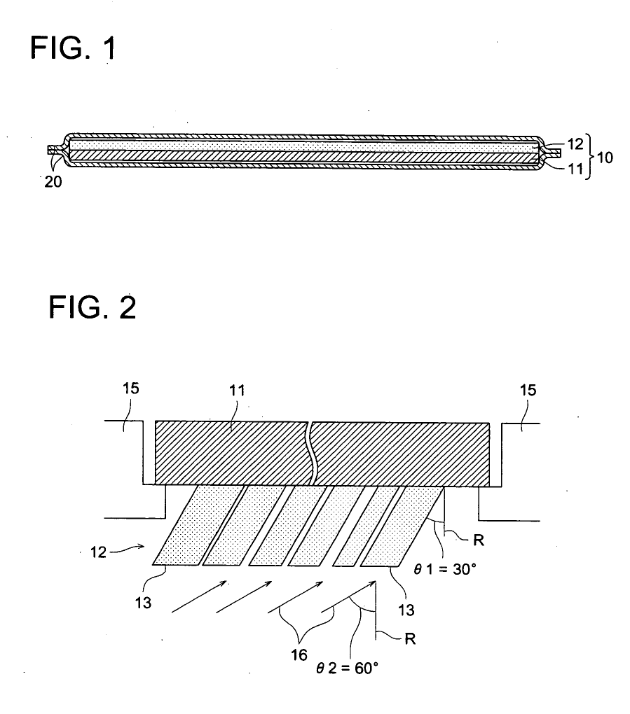

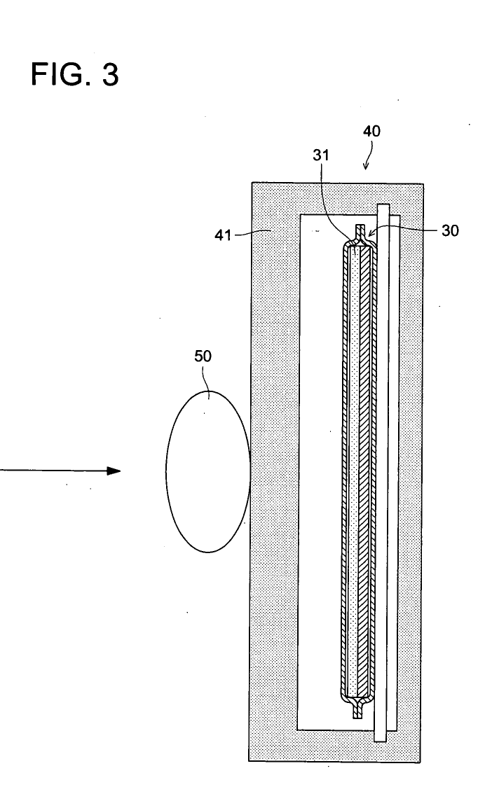

An embodiment of the present invention includes a package, for example, as shown in FIG. 1. It is characterized that: in a radiation image conversion panel in which a stimulable phosphor layer 12 provided on a substrate 11, is sealed by a sealing material 20 (also called as a moisture protective film) to form a package, and X-ray is irradiated on the stimulable phosphor layer 12 from the substrate 11 side, an inert gas selected from the group consisting of N₂, He, Ne, Ar, Kr and Xe is filled on the stimulable phosphor layer 12 side of the substrate 11. FIG. 10 in FIG. 1 indicates a phosphor panel.

Another embodiment of the present invention includes a package characterized in that: in the radiation image conversion, the stimulable phosphor layer includes the stimulable phosphor expressed by General Formula (1)
M¹X.aM²X′₂bM³X″₃:eA Formula (I)
wherein, M¹ represents an alkali metal atom selected from the group consisting of Li, Na, K, Rb and Cs; M² represents a divalent metal atom selected from the group consisting of Be, Mg, Ca, Sr, Ba, Zn, Cd, Cu and Ni; M³ represents a trivalent metal atom selected from the group consisting of Sc, Y, La, Ce, Pr, Nd, Pm, Sm, Eu, Gd, Tb, Dy, Ho, Er, Tm, Yb, Lu, Al, Ga and In, X, X′ and X″ each represent independently a halogen atom selected from the group consisting of F, Cl, Br and I; A represents a metal atom selected from the group consisting of Eu, Tb, In, Ce, Tm, Dy, Pr, Ho, Nd, Yb, Er, Gd, Lu, Sm, Y, Tl, Na, Ag Cu and Mg; and a, b and e each represents a number in a range of 0≦a<0.5, 0≦b<0.5 and 0<e≦0.2, respectively.

Another embodiment of the present invention includes a package characterized in that: in the radiation image conversion panel of the present invention, M¹ in General Formula (1) is at least one kind of alkaline metal selected from the group consisting of K, Rb, and Cs.

Another embodiment of the present invention includes a package characterized in that: in the radiation image conversion panel of the present invention, X in General Formula (1) is at least one kind of halogen Br or I.

Another embodiment of the present invention includes a package characterized in that: in the radiation image conversion panel of the present invention, M² in General Formula (1) is at least one kind of bivalent metal selected from Be, Mg, Ca, Sr and Ba.

Another embodiment of the present invention includes a package characterized in that: in the radiation image conversion panel of the present invention, M³ in General Formula (1) is at least one kind of trivalent metal selected from the group consisting of Y, La, Ce, Sm, Eu, Cd, Lu, Ga and In.

Another embodiment of the present invention includes a package characterized in that: in the radiation image conversion panel of the present invention, b in General Formula (1) shows a numeric value in a range of 0≦b≦10⁻².

Another embodiment of the present invention includes a package characterized in that: in the radiation image conversion panel of the present invention, A in General Formula (1) is at least one kind of metal selected from the group consisting of Eu, Cs, Sm, Tl and Na.

Another embodiment of the present invention includes a package characterized in that: in the radiation image conversion panel of the present invention, as shown in FIG. 2, the stimulable phosphor layer has a columnar (or pillar) crystal 13 of the stimulable phosphor.

Another embodiment of the present invention includes a package characterized in that: in the radiation image conversion panel of the present invention, the columnar crystal 13 has the stimulable phosphor expressed by General Formula (2).
CsX:A Formula (2)

Herein, X expresses Br or I, and A expresses Eu, In, Ga or Ce.

According to the present invention, because the inert gas sealed on the stimulable phosphor layer side of the substrate, is excited by X-ray which is irradiated from the substrate side and which transmits the stimulable phosphor layer, or weak X-ray which transmits the radiation image conversion panel and is scattered by the back objects and is incident again on the radiation image conversion panel, and a very weak light whose wavelength is near the excitation light of the stimulable phosphor, is emitted, noises near the surface of the stimulable phosphor layer can be erased, and the contrast or sharpness of the reproduction image can be improved.

The present invention will be detailed below. The radiation image conversion panel of the present invention is, as shown in FIG. 1, FIG. 2, composed of a phosphor plate 10 in which a stimulable phosphor layer 12 formed of a prismatic crystal 13 is formed on a part excluding the peripheral part of the one surface of a substrate 11, and a sealing material 20 for sealing the stimulable phosphor layer 12 adhered though a spacer 21 jointed to the peripheral part of the surface of the stimulable phosphor layer 12 side of the substrate 11. Further, the rare gas or N₂ gas is filled between the substrate 11 and the sealing material 20.

As the substrate 11, a resin impregnation carbon fiber (carbon fiber reinforced resin) can be used, and specifically, a carbon fiber in the market (Toho rayon (Co.) made #132, epoxy resin impregnation) is listed. Further, as the substrate 11 of conventional radiation image conversion panel, a substrate having the heat resistance can be arbitrarily selected from the publicly known material, and a metallic sheet formed of a quarts glass sheet, aluminum, iron, tin, chrome, and resin sheet formed of aramid, or a sheet in which these sheets are pasted together, can be used.

As the stimulable phosphor preferably used for the present invention, a substance expressed by General Formula (1) can be used.
M¹X.aM²X′₂.bM³X″₃:eA (1)

Herein, M¹ is at least one kind of alkaline metal selected from the group consisting of Li, Na, K, Rb and Cs, and particularly, it is preferable that M¹ is at least one kind of alkaline metal selected from the group consisting of K, Rb and Cs.

M² is at least one kind of bivalent metal selected from the group consisting of Be, Ca, Sr, Ba, Zn, Cd, Cu and Ni, and particularly, it is preferable that M² is at least one kind of bivalent metal selected from Be, Mg, Ca, Sr and Ba.

M³ is at least one kind of trivalent metal selected from the group consisting of Sc, Y, La, Ce, Pr, Nd, Pm, Sm, Eu, Gd, Tb, Dy, Ho, Er, Tm, Yb, Lu, Al, Ca and In, and particularly, it is preferable that M³ is at least one kind of trivalent metal selected from the group consisting of Y, La, Ce, Sm, Eu, Gd, Lu, Al, Ga and In.

X, X′ and X″ are at least one kind of halogen selected from the group consisting of F, Cl, Br and I, and particularly, it is preferable that X is at least one kind of halogen Br or I.

A is at least one kind of metal selected from the group consisting of Eu, Tb, In, Ga, Cs, Ce, Tm, Dy, Pr, Ho, Nd, Yb, Er, Gd, Lu, Sm, Y, Tl, Na, Ag, Cu and Mg, and particularly, it is preferable that A is at least one kind of metal selected from the group consisting of Eu, Cs, Sm, Tl and Na.

Coefficients a, b, e respectively show numeric values of ranges of 0≦a<0.5, 0≦b<0.5, 0<e≦0.2, and particularly, it is preferable that b shows a numeric value of a range of 0≦b≦10⁻².

It is preferable that the columnar crystal 13 has a stimulable phosphor expressed by General Formula (2).

General Formula (2)
CsX:A

Herein, X expresses Br or I, and A expresses EU, In, Ga or Ce.

The stimulable phosphor is produced by a production method, which will be described below, by using a phosphor material of, for example, the following (a)-(d).

(a) At least one kind or more than two kinds of compounds selected from the group consisting of LiF, LiCl, LiBr, LiI, NaF, NaCl, NaBr, NaI, KF, KCl, KBr, KI, RbF, RbCl, RbBr, RbI, CsF, CsCl, CsBr and CsI.

(b) At least one kind or more than two kinds of compounds selected from the group consisting of BeF₂, BeCl₂, BeBr₂, BeI₂, MgF₂, MgCl₂, MgBr₂, MgI₂, CaF₂, CaCl₂, CaBr₂, CaI₂, SrF₂, SrCl₂, SrBr₂, SrI₂, BaF₂, BaCl₂, BaBr₂, BaI₂, ZnF₂, ZnCl₂, ZnBr₂, ZnI₂, CdF₂, CdCl₂, CdBr₂, CdI₂, CuF₂, CuCl₂, CuBr₂, CuI₂, NiF₂, NiCl₂, NiBr₂ and NiI₂.

(c) At least one kind or more than two kinds of compounds selected from the group consisting of ScF₃, ScCl₃, ScBr₃, ScI₃, YF₃, YCl₃, YBr₃, YI₃, LaF₃, LaCl₃, LaBr₃, LaI₃, CeF₃, CeCl₃, CeBr₃, CeI₃, PrF₃, PrCl₃, PrBr₃, PrI₃, NdF₃, NdCl₃, NdBr₃, NdI₃, PmF₃, PmCl₃, PmBr₃, PmI₃, SmF₃, SmCl₃, SmBr₃, SmI₃, EuF₃, EuCl₃, EuBr₃, EuI₃, GdF₃, GdCl₃, GdBr₃, GdI₃, TbF₃, TbCl₃, TbBr₃, TbI₃, DyF₃, DyCl₃, DyBr₃, Dyl₃, HoF₃, HoCl₃, HoBr₃, HoI₃, ErF₃, ErCl₃, ErBr₃, ErI₃, TmF₃, TmCl₃, TmBr₃, TmI₃, YbF₃, YbCl₃, YbBr₃, YbI₃, LuF₃, LuCl₃, LuBr₃, LuI₃, AlF₃, AlCl₃, AlBr₃, AlI₃, GaF₃, GaCl₃, GaBr₃, GaI₃, InF₃, InCl₃, InBr₃ and InI₃.

(d) At least one kind or more than two kinds of metals selected from the group consisting of Eu, Tb, In, Ga, Cs, Ce, Tm, Dy, Pr, Ho, Nd, Yb, Er, Gd, Lu, Sm, Y, Tl, Na, Ag, Cu and Mg.

The phosphor materials of the above (a)-(d) are weighed so that ranges of a, b, e of General Formula (1) are satisfied, and mixed in the pure water. In this case, by using a mortal, ball mil, mixer mil, they may also be sufficiently mixed.

Next, after a predetermined acid is added so that a pH value C of the obtained mixed liquid is adjusted to 0<C<7, the water content is vaporized.

Next, the obtained material mixture is filled in the heat resistive vessel such as a quarts pot or alumina pot, and baked in the electric furnace. It is preferable that the baking temperature is 500-1000° C. Although the baking time period is different depending on the filling amount, baking temperature of the material mixture, it is preferable that the baking time period is 0.5-6 hours.

As a baking atmosphere, it is preferable that it is a weak reducing atmosphere such as a nitrogen gas atmosphere including a small amount of hydrogen gas, a carbon dioxide gas atmosphere including a small amount of carbon monoxide, a neutral atmosphere such as a nitrogen gas atmosphere, argon gas atmosphere, or a weak acidic atmosphere including a small amount of oxygen gas.

Hereupon, after the filled material is baked once under the above baking condition, the baked material is taken from the electric furnace and powdered, after that, the powder of the baking material is filled again in the heat resistive vessel and put into the electric furnace, and when it is baked again under the same baking condition as the above description, the light emission brightness of the stimulable phosphor can be more enhanced, further, in the case where the temperature of the baking material is cooled from the baking temperature to the room temperature, also when the baking material is taken from the electric furnace and cooled in the air, a desired stimulable phosphor can be obtained, however, it may also be cooled under a same weak reducing atmosphere, same neutral atmosphere, or same weak acidic atmosphere, as it is, as at the time of baking.

Further, when the baking material is moved from a heating section to a cooling section in the electric furnace, and is quickly cooled under the weak reducing atmosphere, neutral atmosphere, or weak acidic atmosphere, the light emission brightness of the obtained stimulable phosphor by the stimulation, can be more enhanced.

The stimulable phosphor layer 12 is formed when the stimulable phosphor is made a evaporation source, and it is vapor phase accumulated on one side surface of the substrate 11. As the vapor phase accumulation method, an evaporation method, sputtering method, CVD method, ion plating method, or the like, can be used.

In the evaporation method, initially, after the substrate 11 is arranged in the evaporation device, the inside of device is exhausted to a degree of vacuum of about 1.333×10⁻⁴ Pa. Next, the stimulable phosphor is arranged in the evaporation device making it an evaporation source, and heating-evaporated by a method such as a resistance heating method, or electron beam method, and the stimulable phosphor is grown to a desired thickness on the surface of substrate 11.

As a result, the stimulable phosphor layer 12 not including a binding material is formed. In the above evaporation process, the stimulable phosphor layer 12 can also be formed in a plurality of times.

Further, in the above evaporation process, it is also possible that a plurality of resistance heating machines or electron beams are used, and a plurality of stimulable phosphor materials are made a evaporation source, and they are co-evaporated, and simultaneously when the stimulable phosphor which is an object, is composed on the substrate 11, the stimulable phosphor layer 12 is formed.

The film thickness of the stimulable phosphor layer 12 is different depending on a purpose of use of a radiation image conversion panel, or a kind of the stimulable phosphor, however, it is more than 50 μm, preferably, 300-700 μm.

When the stimulable phosphor layer 12 is formed by the above vapor phase accumulation method, as the temperature of the substrate 11 on which the stimulable phosphor layer 12 is formed, it is preferable that it is set to 50° C.-400° C., and for a characteristic of the phosphor, 100° C.-250° C. is preferable, and when a resin is used for the substrate 11, the heat resistance of the resin is considered, it is preferable that it is 50° C.-150° C., and more preferably, it is 50° C.-100° C.

FIG. 2 is a view showing a condition that the stimulable phosphor layer 12 is formed by the evaporation on the substrate 11. When an incident angle of a steam flow 12 of the stimulable phosphor to a normal direction (R) of the substrate 11 surface fixed to a substrate holder 15 is defined as θ2 (60° in the view), and an angle of the columnar crystal 13 to be formed to the normal direction (R) of the substrate 11 surface is defined as θ1 (300 in the view), empirically, θ1 is about a half of θ2, and at this angle, the columnar crystal 13 is formed.

It is preferable that a growth angle of the columnar crystal 13 of the stimulable phosphor is 10-70°, and more preferably, it is 20°-55°. To make the growth angle 10-70°, it is preferable that the incident angle is made 20-80°, and to make it 20-55°, it is preferable that the incident angle is made 40-70°. When the growth angle is large, the columnar crystal 13 is too much inclined to the substrate 11, it becomes fragile.

To supply the stimulable phosphor or a steam flow of the stimulable phosphor material by forming a certain angle to the substrate 11 surface, there is a method that an arrangement in which the substrate 11 is inclined each other to the evaporation source, is provided. Alternatively, a method in which the substrate 11 and the evaporation source are arranged in parallel with each other, and which is regulated so that only the oblique component is evaporated on the substrate 11 by the slit from the evaporation surface, may be applied.

In these cases, it is preferable that, as the interval of the shortest portion between the substrate 11 and the evaporation source, they are arranged in almost 10 cm-60 cm corresponding to an average range of the stimulable phosphor.

In the stimulable phosphor layer 12 formed of the columnar crystal 13, to improve the modulation transfer function (MTF), it is preferable that a size of the columnar crystal 13 is 1 μm-50 μm, and more preferably, it is 1 μm-30 μm. That is, when the columnar crystal 13 is thinner than 1 μm, because the stimulable excitation light is scattered by the columnar crystal 13, MTF is lowered, and also when the columnar crystal 13 is more than 50 μm, the directivity of the stimulable excitation light is lowered, and MTF is lowered.

Hereupon, a size of the columnar crystal 13 is a mean value of the diameter in which a sectional area of each columnar crystal 13 is circular-converted when the columnar crystal is observed from a surface in parallel with the substrate, and it is calculated from a microphotograph which includes columnar crystals 13 at least more than 100 pieces in a visual field.

It is preferable that a dimension of an interval between each of columnar crystals is less than 30 μm, more preferably, it is smaller than 5 μm. When the interval exceeds 30 μm, a filling rate of the phosphor in the phosphor layer is lowered, and the sensitivity is lowered.

A thickness of the columnar crystal 13 is influenced by the temperature, degree of vacuum, incident angle of the steam flow, and when they are controlled, the columnar crystal 13 with a desired thickness can be produced.

Further, a filling material such as a bonding agent may be filled in the gap formed between the columnar crystals 13, and excepting that it becomes the reinforcement of the stimulable phosphor layer 12, a material for high light-absorption, a material of high light-reflection may also be filled. Excepting that the reinforcement effect is given by the filing material, it is effective for decreasing the light diffusion toward the lateral direction of the stimulation excitation light incident on the stimulable phosphor layer 12.

In the sputtering method, in the same manner as the evaporation method, after the substrate 11 is arranged in a sputtering device, inside of the device is exhausted once, and is made to the degree of vacuum of about 1.333×10⁻² Pa, and next, an inert gas such as Ar, Ne, as a gas for sputtering, is introduced in the sputtering device, and is made to gas pressure of about 1.333×10⁻¹ Pa. Next, the stimulable phosphor is made a target, and when sputtering is made on it, the stimulable phosphor layer 12 with a desired thickness is grown on the substrate 11.

In the sputtering process, in the same manner as in the evaporation method, each kind of application processing can be used. It is also the same in the CVD method, ion plating method, or the like.

Hereupon, it is preferable that the growing speed of the stimulable phosphor layer 12 in the vapor phase accumulation method is 0.05 μm/min-300 μm/min. When the growing speed is not larger than 0.05 μm/min, the productivity of the radiation image conversion panel is poor, and it is not preferable. Further, when the growing speed exceeds 300 μm/min, the control of the growing speed is difficult, and it is not preferable.

After the stimulable phosphor layer 12 is formed, a sealing material 20 is provided on the surface of the opposite side to the substrate 11 of the stimulable phosphor layer 12. The sealing material 20, can be provided in such a manner that, for example, a moisture protective film or glass is adhered to the substrate 11 on the peripheral edge portion of the stimulable phosphor layer 12. It is preferable that the layer thickness of the sealing material is 0.1-2000 μm.

As the moisture protective resin film, cellulose acetate, nitro-cellulose, poly-methyl methacrylate, polyvinyl butyral, polyvinyl formal, polycarbonate, polyester, polyethylene terephthalate, polyethylene, polyvinylidene chloride, nylon, polyethylene tetra-fluoride, polyethylene chloride tri-fluoride, ethylene tetra-fluoride-propylene hexa-fluoride copolymer, vinylidene chloride-vinyl chloride copolymer, vinylidene chloride-acrylonitrile copolymer, can be used. The resin film is easily processed, and even when the thickness is made less than 100 μm, which is thin, there is no problem for the strength during the production process, and because it is a thin layer, it is preferable at a point of the initial image quality.

Further, these moisture protective resin films may also have layers of inorganic material whose moisture penetrability and oxygen penetrability are low, in a laminated manner. As such an inorganic material, there is SiOₓ (SiO, SiO₂), Al₂O₃, ZrO₂, SnO₂, SiC, SiN, however, in them, particularly, Al₂O₃ or SiOₓ is a light transmission rate is high, and the moisture penetrability and the oxygen penetrability are high, that is, because a clack or micropore is small, and a fine film can be formed, it is particularly preferable. SiOₓ, Al₂O₃ may be individually laminated, however, when both are laminated together, because the moisture penetrability and oxygen penetrability can be made higher, it is more preferable that both of SiOₓ, Al₂O₃ are laminated.

For the lamination of inorganic material on the resin film, a method such as PVD method, sputtering method, CVD method, PE-CVD (Plasma enhanced CVD), can be used. The lamination may be conducted after the phosphor layer is covered by the resin film, or may be conducted before the phosphor layer is covered. It is preferable that the lamination thickness is from 0.01 μm to about 1 μm. Alternatively, the moisture protective resin film in the market on which an evaporation layer is previously formed, may also be used. As such a moisture protective resin film, there is, for example, Toppan Insatsu (Co.) GL-AE, or the like.

The sealing of the stimulable phosphor layer 12 by the sealing material 20 is conducted under the atmosphere of at least one kind of gas by which it is excited by X-ray and the light near the excitation wavelength of the stimulable phosphor is emitted, or under the atmosphere of the mixed gasses of 2 kinds or more. As a gas which is excited by X-ray and which emits the light near the excitation wavelength of the stimulable phosphor, there is a rare gas such as, for example, He, Ne, Ar, Kr, Xe. Which gas is used, is determined by the wavelength of the excitation light of the stimulable phosphor to be used.

It is preferable that the pressure of the above gas is 500-8000 Pa, and it is more preferable that it is 4500-7500 Pa. The substrate 11 and the sealing material 20 may also be directly bonded, however, when they are bonded through a spacer 21, because a gap can be provided between the stimulable phosphor layer 12 and the sealing material 20, and the rare gas can be filled in the gap, it is preferable. Hereupon, the sealing material 20 and the spacer 21 may also be integrally provided. When the stimulable phosphor layer 12 is sealed by the sealing material 20 under the atmosphere of the above gas, the rare gas can be sealed between the stimulable phosphor layer 12 and the sealing material 20.

Alternatively, a bag in which the rare gas is sealed by using the above moisture protective resin film, is formed into the same size as the substrate 11, and after the stimulable phosphor layer 12 is sealed by the sealing material 20, the bag in which the rare gas is sealed, is adhered to the sealing material 20, and the rare gas layer may also be provided on the opposite side to the substrate 11 of the stimulable phosphor layer 12. Or, the stimulable phosphor layer 12 may also be sealed by the bag in which the rare gas is sealed.

The rare gas sealed on the opposite side to the substrate 11 of the stimulable phosphor layer 12 absorbs the X-ray irradiated from the substrate 11 side and transmitted the stimulable phosphor layer 12, or the weak X-ray which transmits the radiation image conversion panel and is scattered by the backward objects and incident again on the radiation image conversion panel, and is excited.

The rare gas which absorbs the X-ray and is excited, emits a weak light of the wavelength near the excitation light of the stimulable phosphor. The emitted light from the rare gas is irradiated on the stimulable phosphor layer 12, and erases the image information near the surface of the stimulable phosphor layer 12.

Because the back scattering X-ray is weak, noises by the back scattering X-ray is recorded only in the vicinity of the surface of the stimulable phosphor layer 12. Accordingly, when the image information near the surface of the stimulable phosphor layer 12 is erased, noises by the back scattering X-ray can be erased, and the contrast or sharpness of the reproduction image can be improved.

### EXAMPLES

The present invention will be described by examples, below. Hereupon, the present invention is not limited to these examples.

Following a method written below, various kinds of radiation image conversion panels are produced.

### Example 1

(Production of the Substrate)

The substrate is made in such a manner that the light reflection layer is provided on one surface of a transparent crystallized glass of 500 μm thickness. In the light reflection layer, a film is formed when titan oxide (made by Furuuchi Chem. Co.) and zirconium oxide (made by Furuuchi Chem. Co.) are evaporated on the substrate by using an evaporation device. In the light reflection layer, the film thickness is adjusted so that a reflection factor of the light of wavelength 400 nm is 85%, and a reflection factor of the light of wavelength 660 nm is 20%.

(Production of the Phosphor Plate)

On the substrate, the stimulable phosphor formed of CsBr: Eu is evaporated, and the stimulable phosphor layer is formed. Initially, it is fixed in a vacuum chamber in the evaporation device, and heated to 240° C. Next, the nitrogen gas is introduced into the vacuum chamber, and a degree of vacuum is made 0.1 Pa. The surface on which the light reflection layer is provided, of the substrate is faced to the evaporation source. The distance between the evaporation source and the substrate is made 60 cm. Further, aluminum slit is arranged between the evaporation source and the substrate, and a steam of the stimulable phosphor is made incident at an angle of 30.0 to the normal direction of the substrate surface. The evaporation is conducted while the substrate is conveyed to the surface direction, and the stimulable phosphor layer having the columnar structure of 300 μm thickness is formed on the substrate, and the phosphor plate is obtained.

(Production of the Moisture Protective Film)

The moisture protective film provided on the stimulable phosphor layer side of the phosphor plate is formed in such a manner that a polyethylene terephthalate (PET 12) whose film thickness is 12 μn, on which various mat-processing are conducted, and PET (VMPET 12, made by Toyo Metalizing Co.) whose film thickness is 12 μm, on which alumina is evaporated, are pasted together with a dry-lamination. For the dry-lamination, a urethane adhesive agent of two-liquid reaction type is used.

Further, the moisture protective film provided on the substrate side of the phosphor plate is formed in such a manner that a 9 μm thick aluminum foil and a 100 μm thick PET are pasted together with the dry-lamination, and a thermal fusion lacquer is applied on the aluminum foil side.

(Sealing of the Phosphor Panel)

The moisture protective films are arranged on both surfaces of the phosphor panel. It is arranged in the vacuum chamber, and after reducing the pressure to 200 Pa, helium gas is flowed in, and the gas in the chamber is replaced. After that, the pressure in the chamber is adjusted again to 7000 Pa, and mutual moisture protective films are fused at the peripheral portion of the phosphor panel by using an impulse sealer under this pressure reduction, and the phosphor panel is sealed, and the radiation image conversion panel is obtained. As a heater of the impulse sealer, a 8 mm width heater is used.

### Example 2

The helium gas in Example 1 is replaced with neon gas, and the radiation image conversion panel is obtained.

### Example 3

The helium gas in Example 1 is replaced with argon gas, and the radiation image conversion panel is obtained.

### Example 4

The helium gas in Example 1 is replaced with krypton gas, and the radiation image conversion panel is obtained.

### Example 5

The helium gas in Example 1 is replaced with xenon gas, and the radiation image conversion panel is obtained.

### Example 6

The helium gas in Example 1 is replaced with nitrogen gas, and the radiation image conversion panel is obtained.

### Comparative Example 1

The helium gas in Example 1 is replaced with the air, and the radiation image conversion panel is obtained.

### Comparative Example 2

The helium gas in Example 1 is replaced with oxygen gas, and the radiation image conversion panel is obtained.

For the radiation image conversion panel of the above Examples 1-6 and Comparative examples 1-2, the following evaluation is conducted.

(Evaluation of Contrast)

A 40 mm thick lead disk is copied on the radiation image conversion panel, and the X-ray of tube voltage 80 kVp is uniformly irradiated on it. After that, the radiation image conversion panel is scanned by a semiconductor laser (660 nm) from the stimulable phosphor layer side, and the stimulable phosphor layer is excited, the stimulation light-emission is received by the light receiving unit (a photoelectric multiplier of the spectral sensitivity S-5), and the image is read. The obtained image is outputted by the laser write type film printer. The output image is visually observed, and the contrast of the lead disk part (white) and its peripheral part (black) is estimated in 5-stage according to the following standards. Hereupon, when it is under the rank 3, it is judged that it is not practically suitable for the diagnosis.

5: The difference of lightness of the lead disk peripheral edge part, and of white and black can be clearly confirmed.

4: Although the lead disk peripheral edge part is slightly blurred, the difference of lightness of white and black can be almost clearly confirmed.

3: The lead disk peripheral edge part is observed in a blurred manner, and the difference of lightness of white and black is not slightly clear.

2: The difference of lightness of the lead disk peripheral edge part and white and black is not clear, and the lead disk size is not reproduced.

1: The shape of the lead disk and the difference of lightness of white and black are not clear, and whiteness degree of the central section is also low.

When the radiation image conversion panel (Examples 1-6) in which an inert gas such as N₂, He, Ne, Ar, Kr, Xe is filled, is compared to a case where the air or O₂ is filled (Comparative examples 1-2), the contrast of the reproduction image is high.

(Initial Brightness)

The X ray of tube voltage 80 kVp is irradiated onto the radiation image conversion panel from the substrate side. After that, the radiation image conversion panel is scanned by the semiconductor laser (660 nm) from the stimulable phosphor layer side, and the stimulable phosphor layer is excited, and the stimulable light-emission is received by the light receiving unit (photo-electronic multiplier of the spectrum sensitivity S-5), and its strength is measured, and displayed in the relative value in which the initial brightness of the radiation image conversion panel of the comparative example 1 is made 1.0.

(Brightness Lowering by X Ray)

After the X ray of 2000 roentgen (80 kV) is intermittently irradiated on the radiation image conversion panel, the panel is left as it is for 2 days, under a fluorescent lamp of 6000 Lux whose ultraviolet ray is cut, and the X ray information is perfectly erased. After that, the stimulable light-emission strength is measured in the same method as the measurement of initial brightness, and the relative brightness after the irradiation of 2000 roentgen is displayed in the relative value in which the initial brightness is made 100.

(Brightness Lowering by the Humidity)

After the humidity deterioration processing is conducted on the radiation image conversion panel for 50 days under the environment of temperature 40 C, humidity 90%, the stimulable light-emission strength is measured in the same method as in the measurement of the initial brightness, and the relative brightness after the humidity deterioration processing is displayed in the relative value in which the initial brightness is made 100.

The evaluation results are shown in Table 1.

TABLE 1

| | | | | X-ray | Humidity |
|---|---|---|---|---|---|
| | | | Initial | bright- | bright- |
| | Filled | | bright- | ness | ness |
| | gas | Contrast | ness | lowering | lowering |
| Example 1 | He | 4 | 1.0 | 70 | 91 |
| Example 2 | Ne | 5 | 1.0 | 72 | 91 |
| Example 3 | Ar | 4 | 1.0 | 72 | 91 |
| Example 4 | Kr | 5 | 1.0 | 72 | 91 |
| Example 5 | Xe | 5 | 1.0 | 70 | 91 |
| Example 6 | N₂ | 3 | 1.0 | 70 | 98 |
| Comparative | Air | 3 | 1.0 | 70 | 91 |
| Example 1 | | | | | |
| Comparative | O₂ | 2 | 0.9 | 61 | 85 |
| Example 2 | | | | | |

In the radiation image conversion panel in which the rare gas is filled (Examples 1-5), as compared to a case where the air is filled (Comparative Examples 1-2), the contrast is high. Further, in the radiation image conversion panel in which the nitrogen gas is filled (Example 6), as compared to the Comparative Example 1, the brightness lowering after the humidity deterioration processing is small. Further, in the case where the oxygen is filled (Comparative Example 2), the contrast is low, the initial brightness is also lowered, and the brightness lowering by the irradiation of X ray is low, the brightness lowering after the humidity deterioration processing is large, and practically, it is not suited for the diagnosis.

As described above, when any one of gasses of the rare gas, carbon dioxide gas, and nitrogen gas is filled in the radiation image conversion panel, a specific performance such as the contrast, brightness, durability, can be improved. Hereupon, these gasses may also be individually used, or more than 2 kinds of gasses are mixed and may also be used.

1. A package comprising:
(i) a radiation image conversion panel containing a substrate having thereon a phosphor layer; and
(ii) a moisture protective film surrounding the radiation image conversion panel,
wherein a space formed by an inner surface of the moisture protective film and a surface of the phosphor layer is filled with a gas selected from the group consisting of N₂, He, Ne, Ar, Kr and Xe.

2. The package comprising the radiation image conversion panel and the moisture protective film of claim 1,
wherein the gas in the space is a rare gas selected from the group consisting of He, Ne, Ar, Kr and Xe.

3. The package comprising the radiation image conversion panel and the moisture protective film of claim 1,
wherein the gas in the space is a nitrogen gas.

4. A method for producing a package comprising a radiation image conversion panel and a moisture protective film surrounding the radiation image conversion panel, the method comprising the steps of:
(i) providing the radiation image conversion panel containing a substrate having thereon a phosphor layer;
(ii) enveloping the radiation image conversion panel with a moisture protective film which surrounds the radiation image conversion panel thereby forming the package, and
(iii) introducing a gas selected from the group consisting of N₂, He, Ne, Ar, Kr and Xe in a space formed by an inner surface of the moisture protective film and a surface of the phosphor layer is filled.

5. The package comprising the radiation image conversion panel and the moisture protective film of claim 1, wherein the phosphor layer of the radiation image conversion panel contains an alkali metal halide stimulable phosphor represented by Formula (I):
M¹X.aM²X′₂bM³X″₃:eA Formula (I)
wherein, M¹ represents an alkali metal atom selected from the group consisting of Li, Na, K, Rb and Cs; M² represents a divalent metal atom selected from the group consisting of Be, Mg, Ca, Sr, Ba, Zn, Cd, Cu and Ni; M³ represents a trivalent metal atom selected from the group consisting of Sc, Y, La, Ce, Pr, Nd, Pm, Sm, Eu, Gd, Tb, Dy, Ho, Er, Tm, Yb, Lu, Al, Ga and In, X, X′ and X″ each represent independently a halogen atom selected from the group consisting of F, Cl, Br and I; A represents a metal atom selected from the group consisting of Eu, Tb, In, Ce, Tm, Dy, Pr, Ho, Nd, Yb, Er, Gd, Lu, Sm, Y, Tl, Na, Ag Cu and Mg; and a, b and e each represents a number in a range of 0≦a<0.5, 0≦b<0.5 and 0<e≦0.2, respectively.

6. The package comprising the radiation image conversion panel and the moisture protective film of claim 5,
wherein M¹ in Formula (I) represents an alkali metal atom selected from the group consisting of K, Rb and Cs.

7. The package comprising the radiation image conversion panel and the moisture protective film of claim 5, wherein X in Formula (I) represents Br or I.

8. The package comprising the radiation image conversion panel and the moisture protective film of claim 5, wherein M² in Formula (I) represents a divalent metal atom selected from the group consisting of Be, Mg, Ca, Sr and Ba.

9. The package comprising the radiation image conversion panel and the moisture protective film of claim 5, wherein M³ in Formula (I) represents a trivalent metal atom selected from the group consisting of Y, La, Ce, Sm, Eu, Gd, Lu, Al, Ga and In.

10. The package comprising the radiation image conversion panel and the moisture protective film of claim 5, wherein b in Formula (I) represents a number in a range of 0≦b<10⁻².

11. The package comprising the radiation image conversion panel and the moisture protective film of claim 5,
wherein A in Formula (I) represents a metal atom selected from the group consisting of Eu, Cs, Sm, Tl and Na.

12. The package comprising the radiation image conversion panel and the moisture protective film of claim 5,
wherein the phosphor layer of the radiation image conversion panel contains the stimulable phosphor having a columnar crystal structure.

13. The package comprising the radiation image conversion panel and the moisture protective film of claim 12,
wherein the stimulable phosphor contained in the phosphor layer is represented by Formula (II):
CsX:A Formula (II)
wherein X represents Br or I; and A represents Eu, Ga or Ce.
